(19) United States
(12) Patent Application Publication
(10) Pub. No.: US 2007/0024873 A1
(43) Pub. Date: Feb. 1, 2007

(54) Image forming apparatus, program for printing with marks added, and method for printing with marks added

(75) Inventors: Kazumi Murata, Mishima-shi (JP); Makoto Harigae, Shinagawa-ku (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/191,724

(22) Filed: Jul. 27, 2005

(51) Int. Cl. G06F 3/12

(52) U.S. Cl. 358/1.1; 358/1.9

(57) ABSTRACT

There is disclosed an image forming apparatus, a program for printing with marks added, and a method for printing with marks added, which facilitate adding of marks to print data and reediting thereof. The image forming apparatus performs printing of data constituted by print data added with marks, and comprises: a print data storage section that stores print data; a marking data storage section that stores, as marking data, a character attribute indicative of a preset expression method such as character decoration; and a marking-printing section that prints a result of applying the character attribute to the print data.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

This patent is related to ______, which is incorporated herein by reference.

### BACKGROUND OF THE INVENTION

1. Field of the Invention

The present invention relates to an image forming apparatus which prints out print data with marks added, a program for printing with marks added, and a method for printing with marks added.

2. Description of the Related Art

Conventionally, an image forming apparatus such as an MFP (Multi Function Peripheral) edits print data itself, and stores and prints out the print data as print data with marks added, in case where print data transmitted via a network from image data obtained by a scanner or from another PC (Personal Computer) is printed out with marks added.

However, there is a case that original print data has to be printed out or marks have to be revised and added again after marks have once been added to print data by a method as described above. In this case, it is necessary to scan again the original print data by a scanner or to retransmit the original data stored in another PC, and to edit again and recover the print data, etc. If marks should be added by the above-described method on the presumption that original print data would be used later, edited print data may be stored as another file. However, an extra storage volume is needed for new print data, i.e., for the another file.

The present invention has been made to solve the problems described above, and has an object of providing an image forming apparatus, a program for printing with marks added, and a method for printing with marks added, which facilitate making and reediting of print data with marks added.

### DESCRIPTION OF THE DRAWINGS

FIG. 1 is a block diagram showing an example of the structure of an MFP according to the present invention;

FIG. 2 is view showing an example of a marking data select screen for editing, according to the present invention;

FIG. 3 is a view showing an example of a marking data edit screen, according to the present invention;

FIG. 4 is a flowchart showing an example of printing operation according to the present invention;

FIG. 5 is a view showing an example of marking data select screen, according to the present invention; and

FIG. 6 is a view showing an example of marking data select screen for printing, according to the present invention.

### DETAILED DESCRIPTION OF THE INVENTION

Hereinafter, an embodiment of the present invention will be described with reference to the drawings.

Throughout this description, the embodiments and examples shown should be considered as exemplars, rather than limitations on the apparatus and methods and programs of the present invention.

In the present embodiment, MFP will be described as an example of an image forming apparatus.

At first, the structure of the MFP according to the present invention will be described.

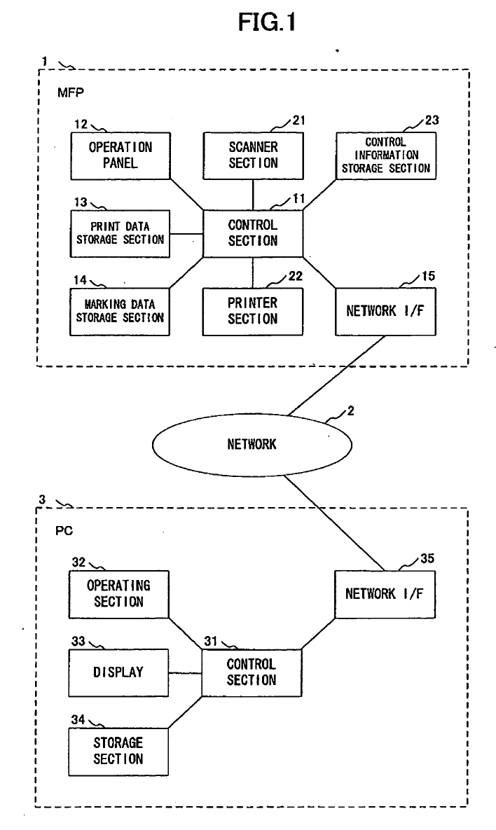

FIG. 1 is a block diagram showing an example of the structure of the MFP according to the present invention. The MFP 1 is connected to a PC 3 via a network 2. The MFP 1 has a control section 11, operation panel 12, print data storage section 13, marking data storage section 14, network I/F (Interface) 15, scanner section 21, printer section 22, and control information storage section 23. Also, the PC 3 has a control section 31, operating section 32, display 33. storage section 34, and network I/F 35.

The control section 11 plays a role of performing various processings in the MFP 1, and another role of executing programs stored in the control information storage section 23, to realize various functions. The control information storage section 23 is constituted by, for example, a ROM, RAM, or the like, and plays a role of storing various information and programs used by the MFP 1.

The control section 31 also plays a role of performing various processing in the PC 3, and another role of realizing various functions by executing programs stored in the storage section 34. The storage section 34 is constituted by, for example, a ROM, RAM, and the like, and plays a role of storing various information and programs used by the PC 3.

In the MFP 1, the control section 11 controls respective sections of the MFP 1. The operation panel 12 displays information from the control section 11, and transfers manipulation by a user to the control section 11. The print data storage section 13 stores print data obtained by the scanner section 21 as well as print data received by the network I/F 15. The marking data storage section 14 stores marking data inputted from the operation panel 12, and marking data received via the network I/F 15. The network I/F 15 communicates with another network I/F 35 of the PC 3 via the network 2. The scanner section 21 obtains print data such as an image, and stores the data into the print data storage section 13. The printer section 22 performs printing, based on print data in the print data storage section 13 and marking data in the marking data storage section 14, or print data in the storage section 34 of the PC 3.

In the PC 3, the storage section 34 stores print data, printer drivers, and the like. The control section 31 controls respective sections of the PC 3, and instructs the MFP 1 on printing by use of the printer drivers. The operating section 32 transfers manipulation by the user to the control section 31. The display 33 displays information from the control section 31. The network I/F 35 communicates with the network I/F 15 of the MFP 1 via the network 2.

Next, operation of the MFP according to the present invention will be described.

The user can carry out manipulation and display concerning operation of the MFP 1 by both of the MFP 1 and PC 3. In the present embodiment, a description will be made of a case where the user manipulates the MFP 1 through the PC 3. In accordance with an instruction from the user, the PC 3 accesses the MFP 1 via the network 2 to perform transmission of print data, setting of marking data, and instructions about printing. This also applies to the case where the user carries out manipulation by the MFP 1. Specifically, when the user carries out manipulation through the MFP 1, the same manipulation as that taken through the operating section 32 is carried out through the operation panel 12. The same display as that on the display 33 is achieved on the operation panel 12.

Storage of print data in the MFP 1 will be described first.

The PC 3 can transmit print data, which is created in accordance with an instruction from the user by the PC 3, to the MFP 1 to print out this data. At this time, in accordance with an instruction from the user at the operating section 32, the control section 31 transmits the print data in the storage section 34 to the MFP 1 from the network I/F 35 via the network 2. The print data received by the network I/F 15 is stored into the print data storage section 13 by the control section 11. The print data is character data and/or image data.

Also in the MFP 1, the control section 11 can store, as print data, image data obtained by the scanner section 21 in accordance with an instruction from the user, into the print data storage section 13.

A next description will be made of operation of setting marking data in the MFP 1.

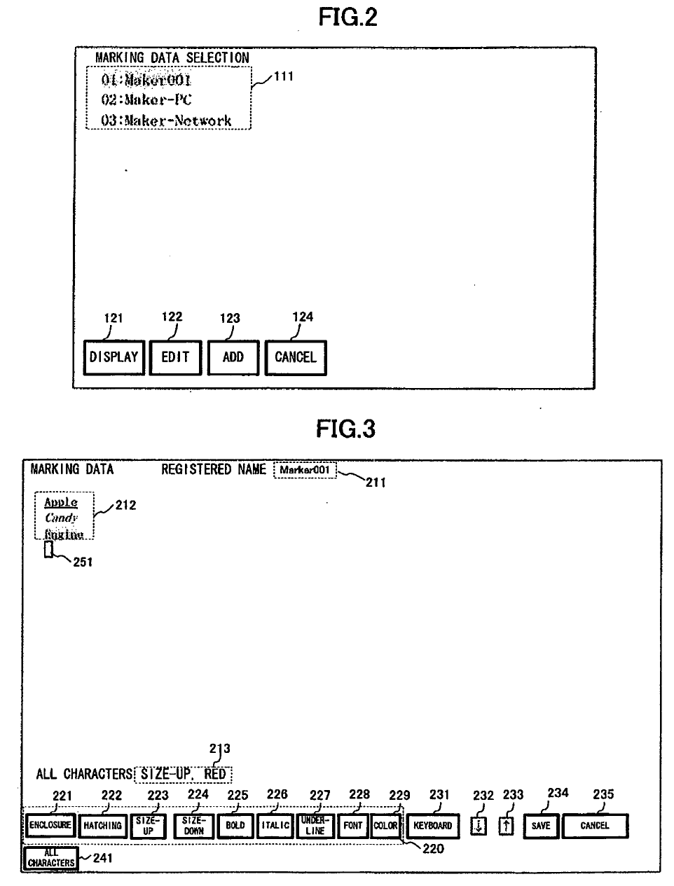

At first, the control section 11 controls the display 33 to show a marking data select screen for editing, in accordance with an instruction about marking data settings from the user by the operating section 32. FIG. 2 is a view showing an example of the marking data select screen for editing, according to the present invention. The marking data select screen for editing shows a list 111 of existing marking data items stored in the marking data storage section 14, a show icon 121, an edit icon 122, an add icon 123, and a cancel icon 124.

If an existing marking data is edited, the user selects a marking data item and press down the edit icon 122. Then, a marking data edit screen for editing the contents of the selected marking data is displayed. Further, if a new marking data item is added, the user presses down the add icon 123. Then, a marking data edit screen for setting a new marking data item is displayed. Alternatively, if an existing marking data item is referred to, the user selects a marking data item and presses down the show icon 121. Then, a screen showing the contents of the selected marking data item is displayed. Alternatively, if a marking data setting is cancelled, the user presses down the cancel icon 124. Then, the marking data setting is cancelled.

Next, the marking data edit screen will be described. FIG. 3 is a view showing an example of the marking data edit screen according to the present invention. The marking data edit screen shows a registered-name column 211 of a marking data item, a marking-target character display 212 showing a list of marking-target characters registered in marking data item, and an all-character attribute column 213 targeting all characters. A marking-target character is a character to which a mark is added in print data. A marking-target character to be displayed is applied with a character attribute indicative of an expression method of a decoration which is set corresponding to the marking-target character. The marking data edit screen further shows attribute icons 220 for setting character attributes, a keyboard icon 231 for inputting a marking-target character by a keyboard, up and down icons 232 and 233 to move a cursor for inputting a marking-target character, a save icon 234 to store a result of edited marking data, a cancel icon 235 to cancel the edit result, and an all-character icon 241 to set an all-character attribute for all characters.

There are kinds of character attribute, e.g., “enclosure” for enclosing a character, “hatching” for hatching a character, “size-up” for enlarging the size of a character, “size-down” for reducing the size of a character, “bold” for making a character bold, “italic” for setting a character in italics, “underline” for underlining a character, “font” for setting the font of a character, and “color” for setting the color of a character. As attribute icons 220 corresponding to these kinds of attribute, an enclosure icon 221, hatching icon 222, size-up icon 223, size-down icon 224, bold icon 225, italic icon 226, underline icon 227, font icon 228, and color icon 229 are displayed.

To set a marking-target character, the user inputs a character at the location of the cursor 251. To set an attribute of a marking-target character, the user selects a marking-target character in the marking-target character display 212, and thereafter presses down an attribute icon 220. The character attribute set by use of the attribute icon 220 is reflected on the marking-target character display 212. For example, if a marking-target character is selected and the underline icon 227 is pressed down, the marking-target character selected in the marking-target character display 212 is underlined.

To set an all-character attribute, the user presses down the all-character icon 241 and thereafter presses down an attribute icon 220. Thus, an attribute is set over all characters, and is displayed in the all-character attribute column 213. To release the all-character attribute which has once been set, the all-character icon 241 is pressed down again, and thereby, the character attribute in the all-character attribute column 213 shows up in gray which means that the attribute is released. Further, to set again the all-character attribute which has once been released, the all-character icon 241 is pressed down again, and thereby, the all-character attribute column 213 recovers a normal display state from the gray display state. and the character attribute which has been set is displayed.

After editing, the user presses down the save icon 234, and the editing thereby ends. If a new registered name has been inputted to the registered-name column 211, registration is newly carried out. Otherwise, if no change has been made to the registered name in the registered-name column 211, edited data is stored, overwritten over data of the exiting registered name.

Next, printing operation of the MFP 1 will be described.

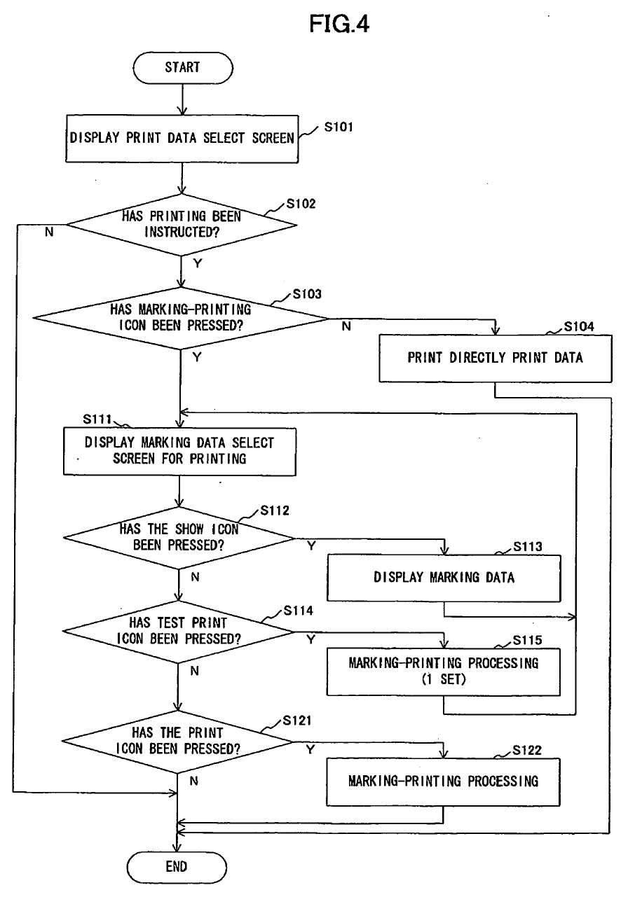

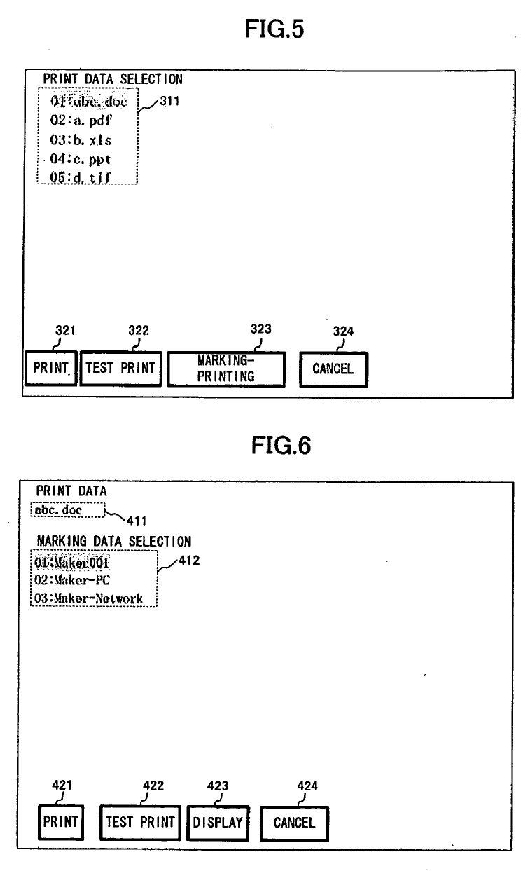

FIG. 4 is flowchart showing an example of printing operation according to the present invention. First, when the user inputs an instruction on printing a print data item through the operating section 32, the control section 11 displays a print data select screen on the display 33 (S101). The print data select screen will now be described. FIG. 5 is a view showing an example of a marking data edit screen according to the present invention. This print data select screen shows a print data list 311 to select a print data item, a print icon 321, a test print icon 322, a marking-printing icon 323, and a cancel icon 324 to cancel printing. Next, the control section 11 determines whether or not an instruction on printing has been inputted through the operating section 32, i.e., whether or not a print data item has been selected and whether or not any of the print icon 321, test print icon 322, and marking-printing icon 323 has been pressed down are determined (S102). If no instruction on printing has been inputted (S102, N), this flow is terminated.

Otherwise, if an instruction on printing has been inputted (S102, Y), the control section 11 determines whether a pressed icon is the marking-printing icon 323 or not (S103). If the pressed icon is not the marking-printing icon 323 (S103, N), the control section 11 controls the printer section 22 to print out directly the selected print data item (S104), and ends this flow.

If the pressed icon is not the marking-printing icon (S103, Y), the control section 11 displays a marking data select screen for printing, on the display 33 (S111). FIG. 6 is a view showing an example of the marking data select screen for printing, according to the present invention. The marking data select screen for printing shows a print data column 411, a marking data list 412 to select a marking data item, a print icon 421, a test print icon 422, a show icon 423, and a cancel icon 424 to cancel printing.

Next, the control section 11 determines whether or not a marking data item has been selected by user's operation through the operating section 32 and whether or not the show icon 423 has been pressed down (S112). If the show icon 423 has been pressed down (S112, Y), a screen for showing the content of the selected marking data item is displayed (S113). Thereafter, the flow returns to the processing step S111. Otherwise, if the show icon 423 has not been pressed down (S112, N), the control section 11 determines whether or not a marking data item has been selected by user's operation through the operating section 32 and whether or not the test print icon 422 has been pressed down (S114). Test printing is a function to print out one test set to check in case where plural sets of print copies are instructed. After execution of this test printing, one set of print copies are reduced from an instructed number of sets of print copies. However, if the instructed number of sets of print copies is one, the number of sets of print copies remains to be one. At this time, if the test print icon 422 has been pressed down (S114, Y), a marking-printing processing of combining the selected print data item and the marking data item and of printing a result of combining the data items is carried out, to execute printing of one set of print copies (S115). The flow then returns to the processing step S111.

Otherwise, if the test print icon has not been pressed down (S114, N), the control section 11 determines whether or not a marking data item has been selected by user's operation through the operating section 32 and whether or not the icon 421 has been pressed down (S121). If the print icon 421 has not been pressed down (S121, N), this flow is terminated. Otherwise, if the print icon 421 has been pressed down (S121, Y), a marking-printing processing of combining the selected print data item and the selected marking data item and of printing out a result of combining these data items is carried out (S122). The flow is then terminated.

Next, operation of the marking-printing processing will be described in detail.

At first, the control section 11 reads a selected print data item and a selected marking data item, and reads character data in the print data item. At this time, if the print data item is image data including characters such as image data obtained by the scanner section 21, an OCR (Optical Character Reader) processing is carried out to prepare character data. Next, if an all-character attribute is set in the marking data item, the control section 11 applies the all-character attribute to all character data. The control section 11 searches the character data for a marking-target character set in the marking data item. Next, the control section 11 applies a corresponding character attribute which has been set in the marking data item, to the marking-target character obtained by the search. Next, the control section 11 makes the printer section 22 print out print data to which the character attribute has been applied.

Note that a marking-printing section corresponds to the control section 11 and the printer section 22 in the embodiment. Further, a marking-printing step corresponds to the processing step S122 in the embodiment. A print data storing step corresponds to the processing executed by the print data storage section in the embodiment. Also, a marking data storing step corresponds to the processing executed by the marking data storage section in the embodiment.

Each step in the processing in the MFP 1 is realized by making the control section 11 execute a program for printing with marks added, which is stored in the control information storage section 23.

The present embodiment has been described with reference to a case in which functions to practice the present invention have been prerecorded in the device. However, the present invention is not limited to this embodiment but similar functions may be downloaded from a network. Alternatively, a recording medium in which similar functions have been stored may be installed in a device. The recording medium may be of any type as far as the recording medium is capable of storing a program, like a CD-ROM, and is readable from the device. Further, functions which are thus obtained in advance by installing or downloading can cooperate with the OS (Operating System) to realize the functions.

Although shown implemented in a multi function peripheral (MFP), the invention may be implemented with any computing device. A computing device as used herein refers to any device with a processor, memory and a storage device that may execute instructions including, but not limited to, multi function peripherals (MFPs) and printers. These computing devices may run any operating system, including, for example, variations of the Linux, Unix, MS-DOS, Microsoft Windows, Palm OS, and Apple Mao OS X operating systems.

Although the techniques discussed herein are described with regard to a compact disk, the techniques may be implemented with any storage media in any storage device included with or otherwise coupled or attached to a computing device. These storage media include, for example, magnetic media such as hard disks, floppy disks and tape; optical media such as compact disks (CD-ROM and CD-RW) and digital versatile disks (DVD and DVD±RW); flash memory cards; and any other storage media. As used herein, a storage device to a device that allows for reading and/or writing to a storage medium. Storage devices include, hard disk drives, DVD drives, flash memory devices, and others.

By data unit, it is meant a frame, cell, datagram, packet or other unit of information.

The present invention has been described in detail with reference to a specific embodiment. It would be obvious to the person skilled in the art that various changes and modifications can be made without deviating from the spirit and scope of the present invention.

As has been specifically described above, according to the present invention, print data itself is not rewritten. Therefore, data in a state before adding marks and data in another state after adding marks are selected and printed out at any time. In addition, since marking data is stored independently from print data, marking data can be changed easily, and one marking data item can be applied to plural print data items.

It is claimed:

1. An image forming apparatus which performs printing of data constituted by print data added with marks, comprising:
a print data storage section which stores print data;
a marking data storage section which stores, as marking data, a character attribute indicative of a preset expression method such as character decoration; and
a marking-printing section which prints a result of applying the character attribute to the print data.

2. The image forming apparatus according to claim 1, wherein
the marking data further has a marking-target character which is a character as a target to be applied with the character attribute in correspondence with the character attribute, and
the marking-printing section searches the print data for the marking-target character, and prints a result of applying the corresponding character attribute to the marking-target character in the print data, obtained by the search.

3. The image forming apparatus according to claim 1, wherein
when the print data is an image including a character, the marking-printing section performs an OCR processing on the image, and prints a result of applying the character attribute to a result of the OCR processing.

4. The image forming apparatus according to claim 2, further comprising a display section which displays, on a screen, a c result of applying the character attribute to the marking-target character, in accordance with a user's instruction.

5. A program for printing with marks added, which makes a computer execute printing of data constituted by print data added with marks, comprising:
a print data storing step which stores print data;
a marking data storing step which stores, as marking data, a character attribute indicative of a preset expression method such as character decoration; and
a marking-printing step which prints a result of applying the character attribute to the print data.

6. The program for printing with marks added, according to claim 5, wherein
the marking data further has a marking-target character which is a character as a target to be applied with the character attribute in correspondence with the character attribute, and
the marking-printing step searches the print data for the marking-target character, and prints a result of applying the corresponding character attribute to the marking-target character in the print data, obtained by the search.

7. The program for printing with marks added, according to claim 5, wherein
when the print data is an image including a character the marking-printing step performs an OCR processing on the image, and prints a result of applying the character attribute to a result of the OCR processing.

8. The program for printing with marks added, according to claim 6, which makes a computer execute a display step which displays, on a screen, a result of applying the character attribute to the marking-target character, in accordance with a user's instruction, between the print data storing step and marking data storing step.

9. A method for printing with marks added, which executes printing of data constituted by print data added with marks, comprising:
a print data storing step which stores print data;
a marking data storing step which stores, as marking data, a character attribute indicative of a preset expression method such as character decoration; and
a marking-printing step which prints a result of applying the character attribute to the print data.

10. The method for printing with marks added, according to claim 9, wherein
the marking data further has a marking-target character which is a character as a target to be applied with the character attribute in correspondence with the character attribute, and
the marking-printing step searches the print data for the marking-target character, and prints a result of applying the corresponding character attribute to the marking-target character in the print data, obtained by the search.

11. The method for printing with marks added, according to claim 9, wherein
when the print data is an image including a character, the marking-printing step performs an OCR processing on the image, and prints a result of applying the character attribute to a result of the OCR processing.

12. The method for printing with marks added, according to claim 10, further comprising a display step which displays, on a screen, a result of applying the character attribute to the marking-target character, in accordance with a user's instruction, between the print data storing step and marking data storing step.
